(19) United States
(12) Patent Application Publication
(10) Pub. No.: US 2023/0394803 A1
(43) Pub. Date: Dec. 7, 2023

(54) METHOD FOR ANNOTATING TRAINING DATA

(71) Applicant: DEEPOMATIC, Paris (FR)

(72) Inventors: Vincent DELAITRE, Paris (FR); Alois BRUNEL, Paris (FR)

(73) Assignee: DEEPOMATIC, Paris (FR)

(21) Appl. No.: 18/033,619

(22) PCT Filed: Oct. 24, 2021
(86) PCT No.: PCT/IB2021/059800

§ 371 Date: Apr. 25, 2023

(30) Foreign Application Priority Data
Oct. 26, 2020 (FR) FR2010970

(51) Int. Cl. G06V 10/774; G06F 16/55

(52) U.S. Cl. CPC G06V 10/7753; G06F 16/55

(57) ABSTRACT

The invention relates to a method of annotating training data for an artificial intelligence comprising the following steps:
storing, in a database, a set of data to be annotated,
storing, in said database, at least a first description of a first facet for data selection in said set of data, said first description being associated with a first task to be performed by said artificial intelligence,
selecting said first facet in said database,
applying said first facet to data in said set of data to obtain first filtered data,
receiving at least a first annotation of said first filtered data, and
store said first annotation in the database in association with said first facet.

### TECHNICAL FIELD OF THE INVENTION

The present invention relates to the field of machine learning. More particularly, the present invention concerns the annotation of data used for machine learning or performance evaluation.

### TECHNICAL BACKGROUND

In the field of machine learning, the so-called “supervised” models must be “trained” on annotated data sets (called “dataset”). These datasets can be images, videos or other. These datasets can also be used to evaluate the performance of the machines by comparing their predictions on the raw data to the annotations.

The data are annotated with concepts that we try to “teach” to machines so that they are able to predict them automatically on data (images, videos, etc.) that are then given to them as input.

For example, in the case of an image classification problem where one seeks to recognize an object, for example a type of animal, present in an image, an image of a dataset containing a cat can be annotated with a “cat” label. In a dataset, a label is thus a metadata associated to the initial data which will inform the machine, during the training phase, about the concept it must recognize.

If, in addition, in a detection problem, one seeks to know the position of the object in the image, it is possible to annotate the object, in addition to the “cat” label, with a bounding region (or “box”) that delimits the extremities of the “cat”. In fact, there may be multiple instances of the same object in the image (i.e., multiple cats in the image), in which case multiple “bounding box” annotations can be added to the dataset. As with the “cat” tag, the “bounding box” tag is a metadata associated with the original data.

Finally, for a segmentation problem, we can even go as far as to delimit the objects (the “cats”) to the nearest pixel.

In the case of a practical application of artificial intelligence (or “AI”), there are often several levels of concepts to annotate.

For example, in the case of an application to assist technicians connecting a house or building to the fiber optic, we want to teach a machine to verify that a certain number of steps have been respected by the technicians based on photographs taken by them.

One of these steps may involve measuring the quality of the signal coming out of the fiber with an optical power meter. The technician must then take a picture of the power meter showing a number on the screen representing the quality of the signal. From the perspective of the AI application, it is natural to annotate the images in three hierarchical levels.

The first level of annotation could be the context in which the photograph is taken. For example, it is a question of determining whether the photograph represents the junction box in the cellar, the fiber outlet box in the living area or the power meter. This is thus a classification problem. We determine what is in the images.

The second level of annotation could be for each context, to annotate the information to be recognized. In the context of the “wattmeter”, we wish for example to annotate the position of the screen to read the number on the screen. It is thus a problem of detection. One determines where an object is located on the images.

The third level of annotation could be, in the case of the power meter screen, the annotation of the value shown on the screen. This is an automatic character recognition (or “OCR”) problem. We determine a text on the images.

These three levels of annotation are an example. In particular, the order in which they are performed depends strongly on the practical case. In other cases, one may very well start with a detection problem, then a classification problem at the second level.

Another example is the annotation of photographs of meal trays. The objective is to train an AI application allowing automatic invoicing in company restaurants. On the basis of a photograph of a meal tray, the AI can determine the price of what it contains.

In this example, the different levels of annotation can be as follows.

The first level of annotation can for example be the annotation of bounding boxes around the different dishes and a label according to the type of dish. This is a detection problem followed by a classification problem. We determine where an object is located and then we determine the type of this object (for example an appetizer, a dish, a dessert etc.).

The second level of annotation can be, for example, for each type of dish, the fine annotation of the nature of the dish (for example for the type “starter”, it can be carrot salad, terrine, etc.).

It appears that the annotation of data is classically done in a hierarchical way and defines a tree (technically, the underlying structure is a forest because there can be several roots which give rise to several annotation trees). The tree is not necessarily regular. There may be little depth on one side and a lot on the other.

The standard practice in the state of the art is to build as many datasets as there are nodes in the tree. In particular, the images are cropped around the objects of interest to normalize the data and facilitate the AI learning process.

For example, the third-level dataset images in the fiber connection example (the power meter reading) would all be cropped so that the power meter screen covers almost the entire image. In fact, the image would typically be cropped using the bounding box of the second level annotation (to detect the presence of the screen).

In the case where there are several boxes in the image (example of the meal tray), each box in an image at a given level produces several images in the lower levels.

This solution has the advantage of being conceptually simple. It is motivated by the technical needs of the AI to be trained. There are as many data sets as there are models to be trained, and in each data set we annotate precisely the list of information that the AI must be able to recognize.

However, this solution has many disadvantages.

First, this solution does not allow for easy propagation of annotation changes, especially in the case of correcting initial annotation errors. For example, in the case of meal trays, if a plate was initially classified as a main course, it will have been injected into the level 2 dataset corresponding to “Main Courses”. However, if it is actually, for example, an entrée and this is corrected in the level 1 dataset gathering all the meal trays, the state of the art method which breaks the problem down into different separate datasets will not reflect these changes. One will have to manually remove the image from the level 2 dataset “Main Dishes” and put it in “Starters”.

Secondly, the difficulties mentioned above can be partially alleviated with computer scripts responsible for checking the integrity of the dataset, or even automating certain tasks such as cropping and filtering images. These scripts are implemented in an ad-hoc way and are most of the time little or not tested, which contributes to increase the risks of errors.

Finally, in cases where the annotations concern a large number of classes, the annotation of a data set following the “classic” method of the prior art is difficult because it is necessary to have in mind all the available classes to annotate without making mistakes.

The capabilities of artificial intelligence depend greatly on the quality of the initial training dataset. We can therefore see that the quality of annotations is a major problem encountered in the field of machine learning.

However, these datasets sometimes contain a number of errors that is too large to allow for efficient training of the artificial intelligence. It is possible to provide correction mechanisms for the artificial intelligence, but this costs resources and may also require a certain amount of time before it reaches the expected level of performance. This can heavily delay an industrial-scale deployment.

As presented above, annotation and dataset generation is very often done in a hierarchical manner. This implies that an annotation error can propagate very deeply in the annotation tree. Once the error has been propagated, it is practically impossible to go back, except to re-annotate the dataset entirely, which is in practice unthinkable. We can then at best correct an annotation error at one level but not at the lower levels, which does not really improve the quality of the dataset since it introduces inconsistencies.

Thus, there is a need to improve the annotation of datasets used in the design of machines used in artificial intelligence applications. The present invention lies within this context.

### SUMMARY OF THE INVENTION

A first aspect of the invention relates to a method for annotating training data for an artificial intelligence comprising the following steps:
store, in a database, a set of data to be annotated,
storing, in said database, at least a first description of a first facet for data selection in said data set, said first description being associated with a first task to be performed by said artificial intelligence,
select said first facet from said database,
applying said first facet to data in said set of data to obtain first filtered data,
receive at least a first annotation of said first filtered data, and
store said first annotation in the database in association with said first facet.

For example, said database includes a plurality of descriptions of a plurality of data selection facets in said set of data and
said first description includes a hierarchical link to a second description of a second data facet in the database,
said first facet is applied to second filtered data obtained by applying said second facet to data of said set of data.

Still for example:
said second facet covers a plurality of subregions in said set of data, and
the first facet is applied on each region on which the second facet is applied.

These sub-regions may be sub-parts of the data in said dataset.

According to embodiments:
annotations are associated with some of said regions covered by said second facet as well as with said second facet, and
the first facet is applied on each region carrying an annotation associated with the second facet.

For example, the description of the first facet includes a filtering condition applied to the annotations associated with said regions as well as said second facet and wherein the first facet is applied only for those regions for which said filtering condition is verified.

According to embodiments, said filtering condition is associated with the regions annotated by said second facet and wherein the first facet is applied only on the data resulting from a cropping by these regions and for which the condition is verified.

According to embodiments, said annotation generates the definition of a region in said set of data, said region is stored in a database in relation to the region used for cropping the annotated data and said annotation is stored in said database in relation to said first facet and said region.

According to embodiments, said annotation does not create a new region and wherein said annotation is stored in said database in relation to said first facet as well as the region used to crop the annotated data.

The method may further comprise a step of displaying said first filtered data to a user, said annotation being received from said user.

AIternatively, said first filtered data is provided as input to an artificial intelligence module implementing said task, said annotation being received from said module.

A second aspect of the invention relates to a machine learning method, for performing a task by an artificial intelligence, comprising the following steps:
accessing a database comprising a set of data and at least one definition of at least one facet for data selection in said set of data, said one definition further comprising at least one annotation associated with said facet,
applying said data selection facet to said set of data to obtain first filtered data,
storing said first filtered data in an annotated training data memory,
associate the said first filtered data with annotations,
perform said task by said artificial intelligence.

For example, said annotation is generated according to a method according to the first aspect of the invention.

A third aspect of the invention relates to a device comprising a processing unit configured to implement steps according to a method according to the first and/or second aspect(s).

### FIGURES

FIG. 1 illustrates data annotation for a root view according to embodiments.

FIG. 2 illustrates data annotation for a region-creating child view according to embodiments.

FIG. 3 illustrates a context of use of data annotation for a non-region-creating child view according to embodiments.

FIG. 4 illustrates that a data item is not annotated by a child view when the condition of the child view is not satisfied according to embodiments.

FIG. 5 schematically illustrates an annotation interface according to embodiments.

FIG. 6 schematically illustrates an annotation statistics interface according to embodiments.

FIG. 7 schematically illustrates an interface for accessing unannotated images according to embodiments.

FIG. 8 schematically illustrates an annotation process according to embodiments.

FIG. 9 shows schematically the structure of a database according to the different embodiments.

FIG. 10 schematically illustrates an example of image annotation of a fiber connection technical assistance application according to embodiments.

FIG. 11 schematically illustrates an annotation process according to embodiments.

FIG. 12 schematically illustrates an annotation process according to embodiments.

FIG. 13 schematically illustrates an annotation according to embodiments.

FIG. 14 illustrates schematically a use of annotations produced according to embodiments.

FIG. 15 shows a schematic illustration of a device according to some embodiments.

### DETAILED DESCRIPTION OF THE INVENTION

In the following, embodiments are described that provide data annotation in a hierarchical manner. They allow, for example, the design of image or video recognition applications based on machine learning. The invention is not limited to this type of application and other types of data can be used.

The embodiments of the invention make it possible to manipulate and store the hierarchical character of annotated concepts, to annotate more efficiently and to decouple the notion of machine learning model from the notion of dataset.

According to the invention, the embodiments take advantage of the hierarchical structure of the data to be annotated to facilitate annotation even though this hierarchical structure is a source of problems in the prior art.

This makes it possible to split an annotation job into several independent subtasks.

The embodiments address the problem of error propagation in prior art models. For example, they allow to automatically take into account the changes of classes to pass them on automatically.

The embodiments also allow annotating data without causing inflation of the data as the annotation proceeds. The generation phase of the actually annotated data can be postponed to an actual training phase.

As described in detail in the following, annotation according to the embodiments takes into account the hierarchical structure of the annotations to be performed. Automatic cropping of the data around the relevant regions to be annotated can be performed for annotation without generating new subsets of the data. It is also possible to filter the images to be annotated to display only the relevant data regions.

In what follows, the principles applicable to the various embodiments of the invention are first presented.

Contrary to the annotation techniques of the prior art, the embodiments of the invention will not focus on creating “sub-datasets” as annotations are made on the dataset. Thus, the inflation of the dataset by the annotation process, which is the source of error propagation in the prior art, is not repeated.

On the contrary, the initial dataset will be kept and we will create a dynamic construction system of datasets (the “facets” or “views”) to which annotations will be associated. Thus, it will be possible to make any manipulation, including corrections on this construction system, without touching the dataset. The “sub-datasets” will be generated on demand, according to the desired use (for example, training an AI) once the construction system has been validated.

The context for implementing the embodiments of the invention is thus as follows.

We consider a set of unstructured data to be annotated to allow the training of an artificial intelligence on a certain number of tasks.

“Data” (unannotated) refers to any type of data that can typically be produced by a sensor, capture device, or manual input device. It can be an image, a video stream, a point cloud, a 3D image made of voxels, a sound stream, a text, a time series, etc.

Annotations are the additional information linked to a piece of data and related to its content. For example, the position of an object in an image and/or its “class” (or “type”).

A “task” refers to any action of a machine that allows it to automatically predict the annotations of a datum, or a subset of the annotations. A large number of tasks can be cited. Some examples are given below.

For a classification task, the annotation to be predicted is a category of object, otherwise called a “class”, among a predetermined list of possible classes. For example, given a picture of an animal, we want to know which animal it is.

For a detection task, the annotation to be predicted is a list of objects present in the image among a list of classes of interest. Each predicted object must indicate a simple delimitation of the object, typically in the form of a bounding box as well as its class. For example, given a video captured by an autonomous car, we want to know where all the vehicles, pedestrians, cyclists, etc. are.

For a segmentation task, the annotation to be predicted is the same as for a detection task, but the objects must be delimited to the nearest pixel.

For an OCR (Optical Character Recognition) task, the goal is to predict the text in an image. For example, reading a license plate number from a photo of a license plate.

For a pose estimation task, the goal is to predict the “pose” of a deformable object. Typically, key parts of the object are identified beforehand and linked by a tree. It is then a matter of predicting the position of the different nodes of the tree if they are visible or to indicate that they are invisible. For example, in the case of estimating the pose of a person, we typically try to locate the head, hands, feet, etc. of each person present in the image.

For a regression task, the goal is to predict a number or a vector (i.e. a list of N numbers, N being known beforehand). For example, the task is to predict the age of a person given a picture of a face.

This list of tasks is of course non-exhaustive but it allows to realize the variety of tasks that can be asked to an AI and thus the variety of possible annotations in a dataset.

When these different tasks contribute to the solution of the same problem by relying on one or more automatic recognition algorithms, it is common that these tasks are organized in a hierarchical manner.

The hierarchy relationship between a task A and a task B can for example appear when the need to annotate data for task B depends on the annotation of that data for task A. This is for example the case where the need to annotate for task B depends on the object class specified in A. In the example of the connection check given in the introduction, this is for example the annotation of the power meter screen which is only relevant in the context where the image actually shows a power meter and has been annotated as such in the first annotation level. It is therefore a question of being able to “filter” the regions to be annotated for task B according to a certain condition on the annotation of task A.

The hierarchy relation can also appear when task B consists in annotating the same data regions as those defined by task A. In the example given in the introduction concerning the meal trays, it is for example a question of annotating the nature of the dish on the image resulting from the cropping of the original image by the region defined in task A.

Hierarchy relationships may appear for any other reason that induces the fact that the annotation for task A can be directly reused to define the annotation need or simplify the annotation process for task B.

As mentioned above, it is common to annotate the same region of a data in different tasks. For example, this is the case when a classification task focuses on annotating the detailed class of an object created during an upstream detection task. A region is a sub-part of a data defined by its extremal values on the different axes of the data (x, y, z for spatial data and/or t for video). When the temporal axis is involved (for example for a video), the spatial position (i.e. in x, y, z) can vary for each value of t between t_min and t_max. The interest of a region is to be able to crop a data to produce a new (sub)data to annotate.

In accordance with the embodiments described in the following, in order to represent the hierarchical relationships between tasks and regions, the notion of “facet” is used. Each annotation task is assigned a unique facet (i.e. a task is linked to a unique facet and vice versa).

A facet is understood by analogy to the term facet in the field of faceted classification-based information retrieval, which gives users the ability to filter data based on the selected facet. In what follows, and without loss of generality, the term “view” is used.

In addition to being linked to a task, a view can be hierarchically attached to another view, called a “parent view” (or conversely a “child view”). A view that does not have a parent view is called a “root view”.

When a view is a child view, it sets a “filter condition” on the parent view's annotation, or “condition”. The data in the parent view that checks the condition defines the child view. This allows to create sub datasets.

An annotation process can have several root views. Formally, the relationship between the views induces a forest structure in the sense of a set of disjoint trees as defined in graph theory.

As described in the following, the views as defined above allow, in embodiments of the invention, filtering and cropping of the regions produced by the parent view to present the annotating user with valid data focused on the regions of interest. As explained in the following, this allows for more efficient annotation. It also allows to manipulate data on the fly in the annotation phase and to reserve the annotated datasets generation phase for the AI training phase.

A more formal definition of views is given below.

We define the set of all possible regions R and we associate a root region r_{i,0}∈R to each of the data dᵢ∈D of the dataset. Thus, each dataset has at least one root view.

We define the cropping function crop: D×R→D which takes as input a data d and a region r and returns the sub-data resulting from the cropping of d by r. Cropping by a root region does not change the data: ∀i, crop(dᵢ, r_{i,0})=dᵢ.

We note {vⱼ|j=1, . . . , n} the set of n views and p: [symbol] → [symbol] (with [symbol] the set of natural numbers) the parent function such that p(j)=0 if vⱼ is a root view and p(j)=k if vₖ is the parent view of vⱼ.

We note annotated(j,r)∈{0,1} the function that defines whether the region r is annotated for the view vⱼ (in addition, we set ∀r∈R, annotated(0,r)=1) and Aⱼ the set of possible annotations for vⱼ (the exact form of Aⱼ depends on the type of task associated with vⱼ classification, detection, etc.).

We also note aⱼ: R→Aⱼ the function that allows to retrieve the annotations of a region already annotated in the view vⱼ.

The set of regions that are annotated in a region r by the view vⱼ is noted regions(j,r).

For example, in a detection task regions(j,r) corresponds to the set of regions defined by the newly annotated bounding boxes. If no region is created (as in the case of a classification task), then we have regions (j,r)={r}. To handle the case of root views, we set regions(0, r_{i,0})={r_{i,0}}.

We note cⱼ: R→{0,1} the function which is 0 or 1 depending on whether the filtering condition of the view vⱼ is valid or not (for any root view vₖ we define ∀r∈R, cₖ (r)=1).

We call R_{i,j} the set of regions to annotate for the view vⱼ on the data dᵢ. We set R_{i,0}={r_{i,0}}, R_{i,j}^{valid}={r|r∈R_{i,p(j)}telle que annotated(p(j),r)=1 et cⱼ(r)=1} and

$${R}_{i , j} = {⋃}_{r ∈ {R}_{i , j}^{valid}} regions ( p ( j ) , r ) .$$

The data presented to the annotation for the view vⱼ is the set of data cropped by the regions to be annotated, i.e. Dⱼ={crop(dᵢ,r)|dᵢ∈D et r∈R_{i,j}}. This data can then be annotated in the same way as the state of the art, i.e. by considering Dⱼ as a stream of data to be annotated that can be taken in isolation from the rest of the annotation process.

Thus, the interaction of a view with its parent view (through the notions of region and condition, defined above) is the means that allows the implementation of the necessary manipulations during annotation in order to accelerate and make reliable the annotation process of the task to which it is attached. This makes it possible to avoid the inflation of data during the annotation phase according to the techniques of the prior art.

In other words, the creation of the notion of “view” allows a dynamic annotation of the data, which has the consequence of not creating sub-datasets as the annotation proceeds. According to the embodiments described below, it is possible to annotate the data without modifying the data itself. It is thus possible to modify any annotation at any time and this with the possibility, which does not exist in the prior art, of passing on these modifications as deeply as one wishes since the list of data to be annotated for a given task and the cropping on the zone of interest are calculated on the fly according to the annotations already present in the parent task.

According to the definitions and formulas stated above, one knows how to formally define the data to be presented to a user (or an automatic process) from an initial set, for annotation. As described in the following, in the annotation process, instead of making direct links between data and annotations, it is here a question of making links between annotations and formalization of the way to obtain the data presented to the user (or the process) from the initial data. This association allows to improve the annotation process.

In the following, the formal equations given above are illustrated for different cases.

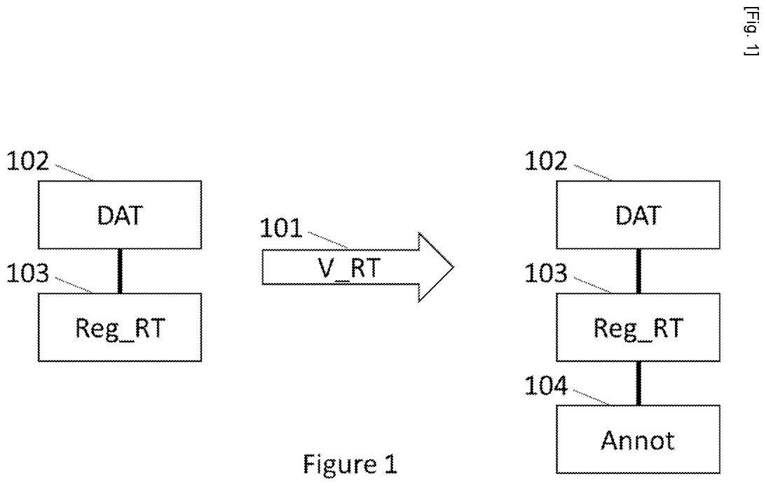

With reference to FIG. 1, we illustrate the case of a root view vᵢ 101 where

the data presented for annotation is exactly the raw data dᵢ of the data set to be annotated. Indeed, the region to be annotated is necessarily the root region 103 which encompasses all the data dᵢ 102. This is found via the above formalism because p(j)=0 therefore R_{i,j}^{valid}=R_{i,0}={r_{i,0}} and so the data presented to the annotation is crop(dᵢ,r_{i,0})=dᵢ. The root view 101 thus behaves like a “standard” annotation task that would follow the state of the art practice of adding annotations 104 to the data set D for the task related to vⱼ. The difference is that the annotation is attached to the root region 103 and not directly to the data 102. In the case where there are multiple root views, all annotations are attached to the same root region 103.

In what follows, we consider cases where the regions to be annotated for a view B are this time those resulting from an annotation of the view A.

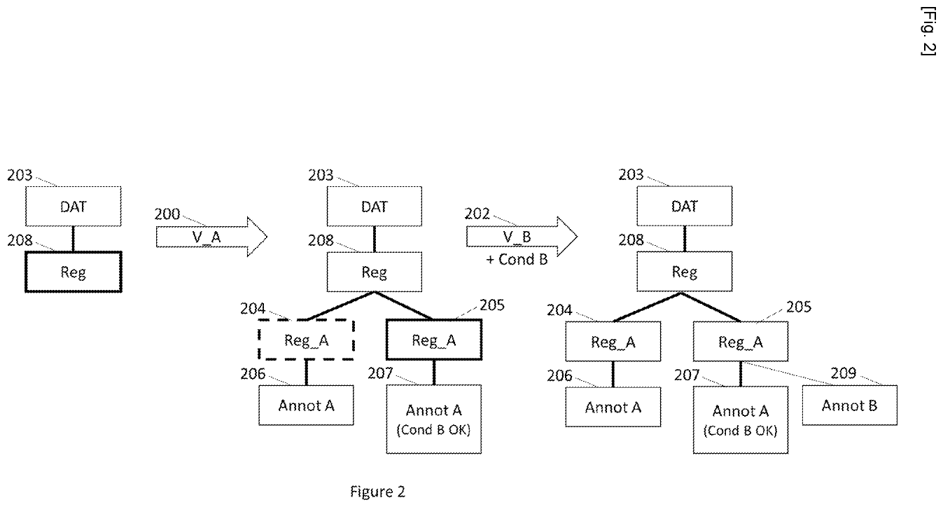

In the example of FIG. 2, we start by applying a parent view A 200 (parent of view B 202) on a data 203 from the data set to be annotated. It is assumed that this parent view A creates new regions A 204 and 205 (for example in the case of a detection task) which receive annotations 206 and 207 respectively. It is assumed that the view A is applied on a root region 208 to simplify the figure (the process would be similar for the case of a non-root region).

It is assumed that the annotations in region 205 (solid line) verify a condition B while those in region 204 do not (dashed line). Thus only the data 203 cropped by region A 205 verifying condition B will be presented in the annotation view according to view B. The data resulting from a cropping by region 204 is not presented.

In general, the data to be annotated for view B 202 is the original data cropped by the regions annotated by view A 200 whose annotation verifies condition B. After the application of view B 202, the annotation 209 is associated with the region 205 that was used to crop the annotated data.

The example in FIG. 2 is very simplified and represents only one initial data 203. If, for example, view A 200 created two regions on a first datum and three regions on a second datum, then there would be 5 datums to annotate for view B 202, derived from cropping each of the 5 regions produced by view A 200.

In the example in FIG. 2, we see that the initial data set always forms a whole without anything being added to it. It is simply different ways of “seeing” it, the views, that are created as we go along and the annotations are associated with these views and the regions that carry them, and not directly with data.

According to the prior art, instead of keeping a single dataset 203, two subsets of the dataset would have been created corresponding to the two tasks of views A and B. For view A, which could for example be a detection view, the dataset would include the data 203 cropped by region 208, annotated by two regions (e.g. bounding boxes and their classes) 204+206 and 205+207. For view B, which could be a classification view, the dataset would have the data 203 cropped by region 205 and annotated by 209.

According to the invention, the data 203 is not modified and the annotations are not directly attached to it. Instead, a representation of views A and B, as well as regions, is created and annotations are associated with these regions. During the annotation process, no new subsets of data are created. Only views are used to generate the data to be annotated and allow the user (or an automatic process) to annotate them. These same views can be used to actually generate the annotated data to give as input to an AI in training phase. In the meantime, the storage and processing of annotations is greatly facilitated because the hierarchy between annotations is automatically preserved, which makes the process of updating (modifying or deleting) annotations more reliable.

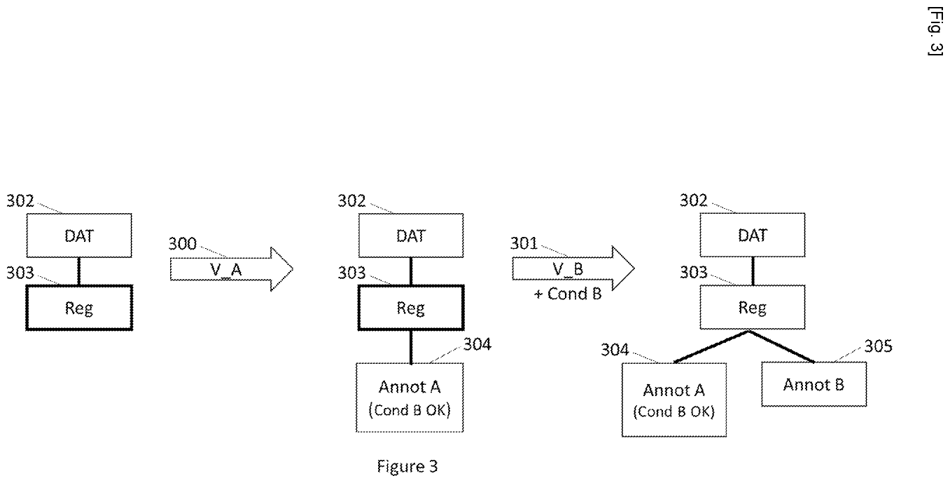

In the example of FIG. 3, the parent view A does not create new regions (for example in the case of a classification task). In this case the annotation for view B is on the same regions as view A.

We start by applying a parent view A 300 (parent of view B 301) on a data 302 from the dataset to be annotated. As indicated, this parent view A 300 does not create new regions as previously. We therefore find the same region 303 after the application of view A 300. This region is associated with the annotation 304. We assume that the view A is applied on a root region 303 to simplify the figure (we could consider the case of a region that is not).

It is assumed that the annotations 304 verify the condition for view B 301. The data to be annotated for view B 301 is then the initial data 302 cropped by region 303. That is, the one already annotated by view A 300. After the application of view B 301, annotation 305 is associated with region 303.

We can see in the example of FIG. 3 that, as in FIG. 2, the initial data set always forms a whole without anything being added to it. It is simply different ways of “seeing” it, the views, that are created as we go along and annotations are associated with these views.

According to the prior art, instead of keeping a single dataset, two subsets of the dataset corresponding to the two tasks of views A and B would have been created. For view A, which could for example be a classification view, the dataset would include the data 302 cropped by region 303 and annotated by 304. For view B, which could also be, for example, a classification view, the dataset would include the data 302 cropped by region 303 and annotated by 305.

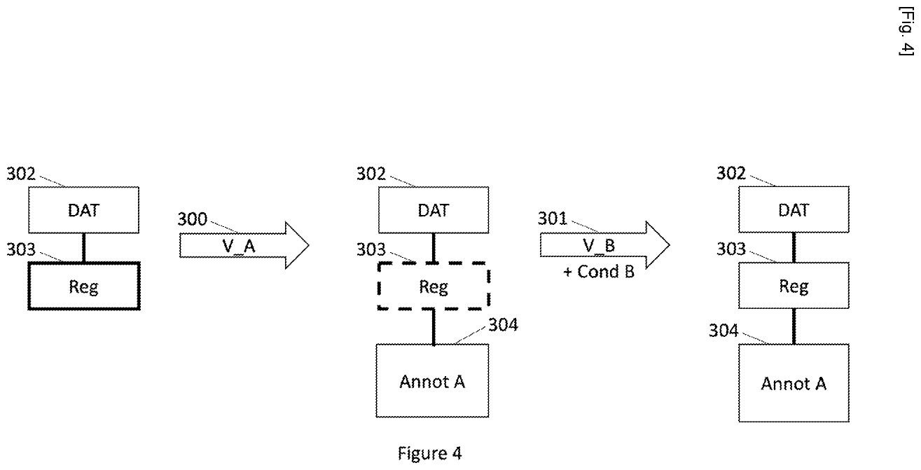

The example in FIG. 4 is similar to FIG. 3 except that this time we consider that the annotations in view A 304 do not satisfy condition B in view B.

In this case, the data region will not be presented to the user for annotation and no annotation will be added (annotation 305 is missing).

Annotation of data according to the above principles can take the form described in the following.

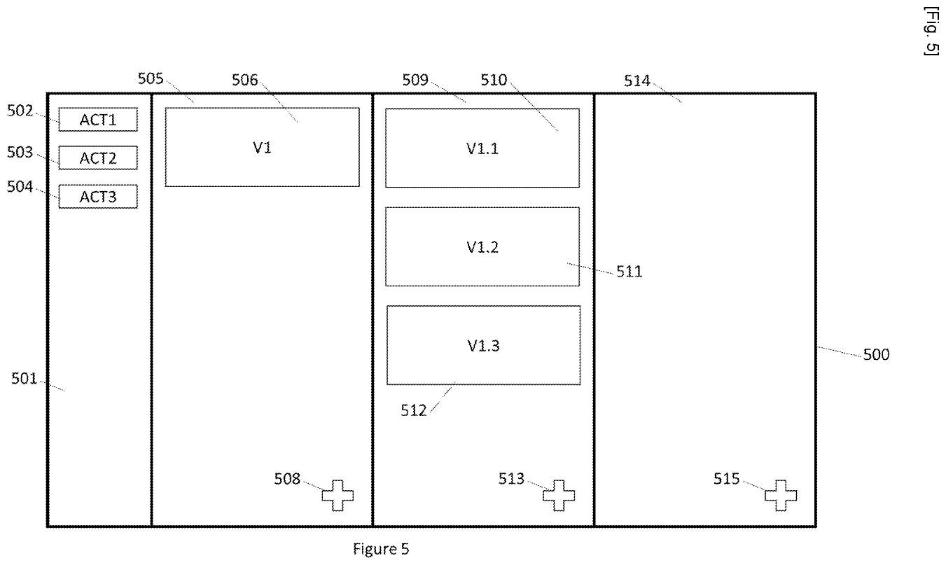

For example, a user can access an interface 500 of an annotation system as shown in FIG. 5. This interface allows to display views and to manipulate hierarchies between them.

Thus, the interface 500 includes an action area 501 with various buttons 502 (ACT1), 503 (ACT2), 504 (ACT3). For example these buttons allow the user to manage the dataset in a general way, for example by adding data, viewing a view map, deleting images, etc.

The interface 500 also includes an area 505 for displaying root views. Here, for brevity, a root view 506 (V1) is shown. Other root views could be present in this area. In this area, a button 508 allows the user to add root views.

The user can select a view, for example 506, and an area 509 similar to 500 appears to display the child views of the selected view. For example, views 510 (V1.1), 511 (V1.2), 512 (V1.3) depend on view 506 (V1) which is therefore a parent view for them. In this zone, a button 513 allows the user to add views dependent on the view selected in zone 500. For example, the user selects the view 506, then clicks on the button 513 to create a dependent view of the view 506.

The process continues recursively as long as there is depth in the view tree. For example, an area 514 is used to display dependent views of the view selected in area 509 and a button 515 is used to add a dependent view to the selected view. In the illustrated example, the view 511 is for example selected but does not contain a child view. The user then clicks on button 516 to create a first dependent view of this selected view.

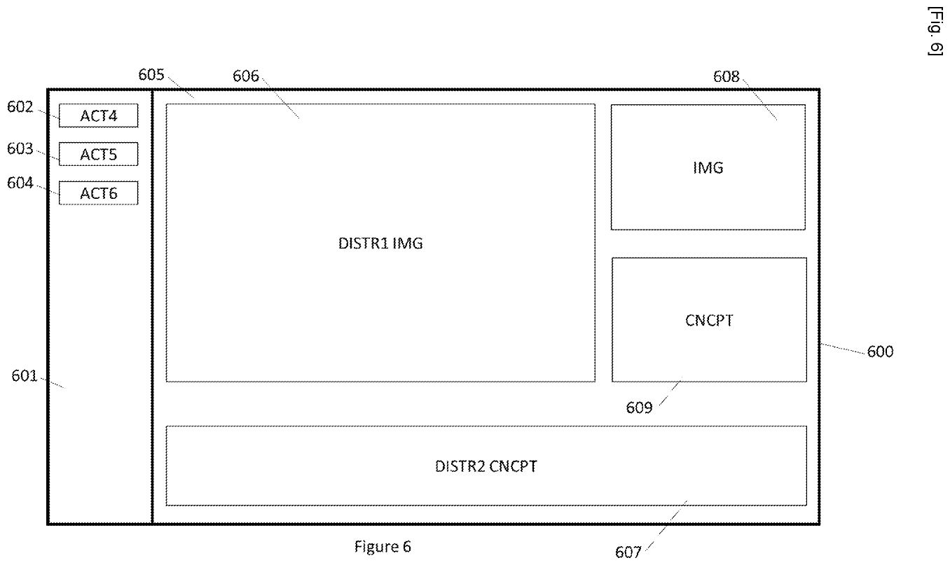

As illustrated in FIG. 6, when clicking on a view in FIG. 5, the user can view statistics related to that view.

FIG. 6 illustrates an interface 600 comprising an action area 601 with a set of buttons 602 (ACT4), 603 (ACT5), 604 (ACT6). For example these buttons allow the user to annotate images, correct annotations, add concepts to be recognized, etc.

The interface 600 further includes an area 605, with a number of windows allowing the user to manage the images in a view. For example, a window 606 (DISTR1 IMG) provides access to a distribution of the images in the view among different uses (one can retrieve the number of training data, unannotated data, or the like). This makes it possible to know for which use the images of the view are intended. A window 607 (DISTR2 CNCPT) gives access to another distribution concerning the concepts that the machine will have to predict. For each concept, we can see the number of images associated with it.

A window 608 (IMG) can give access to the number of images in the view. A window 609 (CNCPT) gives access to the number of concepts associated with the view.

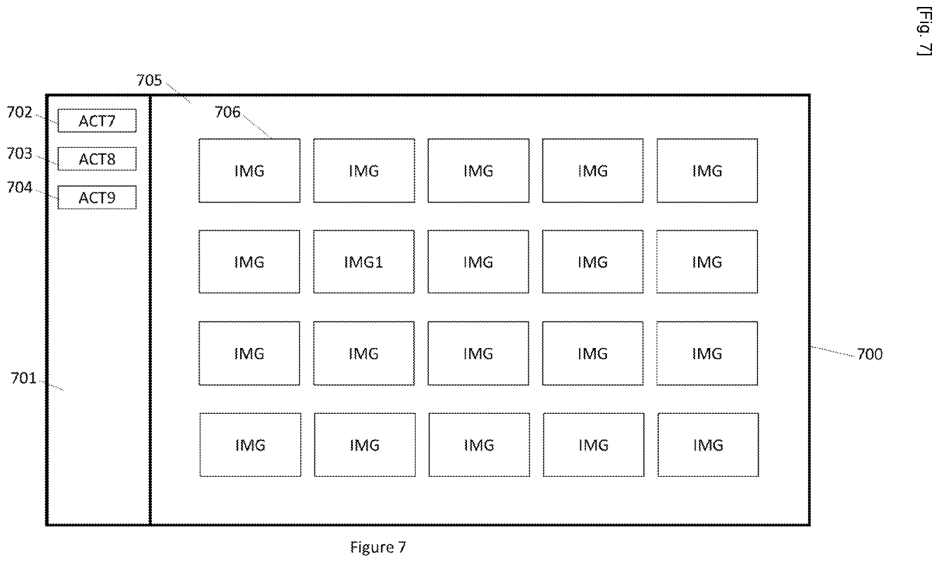

One of the buttons in area 601 can provide the user with access to unannotated images in an interface 700 shown in FIG. 7.

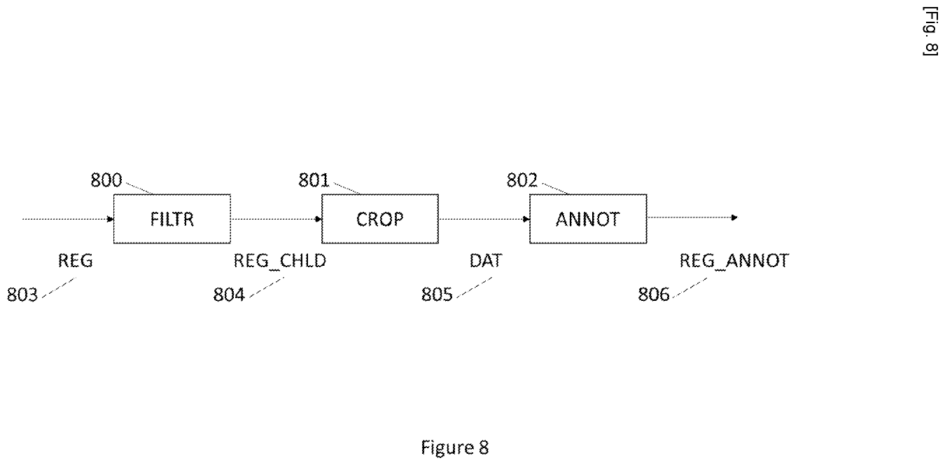

This interface 700 comprises an action zone 701 with a certain number of buttons 702 (ACT7), 703 (ACT5), 704 (ACT9) allowing the user to perform a certain number of actions. These buttons are, for example, the same as those on the interface 600 or may be supplemented by others. According to some examples, it may include a button opening the possibility for the user to annotate a not yet annotated image, thanks to an annotation interface allowing to perform an annotation specific to the type of task related to the view selected in the interface 600. This interface is consistent with state of the art practice and is not described here. That said, unlike the state of the art, it does not apply directly to the annotated data but to the region of interest as described in FIG. 8 below.

The interface 700 further includes an area 705 with all images 706 (IMG) not yet annotated. For example, the user selects an image in the area by clicking on it and is redirected to the image annotation interface for the selected task and view as before.

With interfaces such as those presented above, we can see that the annotation process is totally different from the state of the art. Indeed, the data to be annotated can be displayed to the user “on the fly” according to the different views. We therefore take advantage of the hierarchical nature of the tasks, without creating new data for each annotation.

The data can therefore be annotated automatically according to the parent views. The hierarchy of views in the form of a tree is therefore different from the generation of annotated data as in the prior art. This hierarchy allows a display for adding annotation, not on the data but on the regions produced by the parent views of the view being annotated.

The process is schematically presented in FIG. 8. The user typically annotates the data one after the other. Here we describe how the data stream to be annotated is generated. As input we find the stream of annotated regions 803 (REG) by the parent view of the view selected for annotation, hereafter called current view. If the current view is a root view (i.e. it has no parent view), then this stream consists of all root regions. Then, in step 800 (FILTR), the regions are filtered by the condition to be applied for the annotation according to the current view. At the output, the useful regions 804 (REG_CHLD) for the desired annotation are found. In step 801 (CROP), the data to be annotated is presented, cropped by the useful regions 804. The output is thus the data stream to be annotated 805 (DAT), which is then annotated in step 802. The annotations are attached to the useful region 804 and not to the data generated by the cropping 805, so that the latter can be deleted once annotated. At the output of the process is the annotated region stream for the current view 806 (REG_ANNOT). It is this annotated region stream that will be used instead of the stream 803 for all the child views of the current view. Unlike the prior art, we do not obtain a stream of annotated data directly, but a stream of annotated regions, which are themselves linked to the data that carries them and which is not duplicated.

The process presented above is described in the case of a manual annotation by a human user. However, the annotation can also be performed on the fly by an automatic annotation module. In this case, the process in FIG. 8 remains valid. Step 802 is then implemented by the annotation module. The cropping is still performed to present the data to the module, but it is no longer useful in this case to display the result. This mode of implementation can be useful in cases where an artificial intelligence is already sufficiently trained and gives sufficiently satisfactory results to be able to convert a prediction into an annotation when the confidence score is high enough. We then allow the artificial intelligence to enrich itself by giving it new annotated images.

In practice, the notions of data, views, regions, annotations are stored in database. When the user seeks to view the unannotated data (see FIG. 7), a query to the database is performed to obtain (i) all root regions if the current view is a root view and (ii) all regions already annotated in the parent view and that satisfy the condition of the current view in other cases.

For each annotation, a new “annotation” object is created in the database. This object is linked to the view that produced it and to the region it concerns.

If the task linked to the view does not create a new region but simply enriches the region passed as input (as for example in the case of classification) then the newly created annotation is linked to this region and it is considered as annotated for the current view. The annotation then becomes available for annotation in the child views.

If the view-related task creates new regions (as for example in the case of detection), it is these new regions that become available for annotation in the child views. For practical reasons, these new regions store their parent region (see step 1305 written below) in the database, in particular to allow the deletion of child regions and annotations in cascade as explained below.

The storage of annotations, not linked to data but linked to hierarchical views, allows annotation corrections to be made in a very simple way. For example, if a region is deleted, this allows to rely on the cascading deletion mechanism of a database. AIl regions and annotations that inherit from this deleted region in the child views are automatically deleted.

In addition, when modifying an annotation, one of the difficulties of annotating is to check that the child view filtering condition is not violated, and if so, to correctly delete annotations that have become invalid. Moreover, a region stores the view that created it in order to allow to efficiently delete all regions and annotations from a given view and its children when this view is deleted.

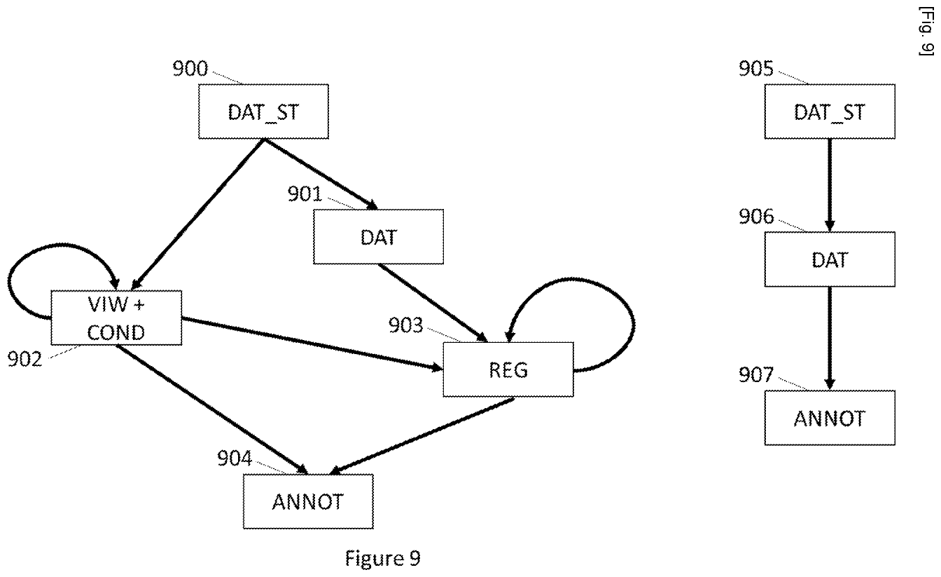

FIG. 9 illustrates a UM L schematic of database according to embodiments.

As can be seen, both the data 901 and the views (with their conditions) 902 are linked to the dataset 900 to which they belong. The regions 903 are linked to the data 901 and to the views (with their conditions) 902 which carry them. Since a view must store a reference to its parent view (this reference is null in the case of a root view), the view table is linked to itself in FIG. 9. In the same way, regions can store their parent region as explained above. Finally, annotations 904 inherit both regions 903 and views and conditions since annotations are linked to both.

In comparison, a schematic of the same type is also shown in FIG. 9 for a prior art annotation database. This time, the structure is much simpler since the annotations 907 are linked to the data 906 which are themselves linked to the dataset 905. The prior art database does not have the notion of a view that allows the on-the-fly creation of data to be annotated according to the annotations of the previous step when the annotation task is hierarchical.

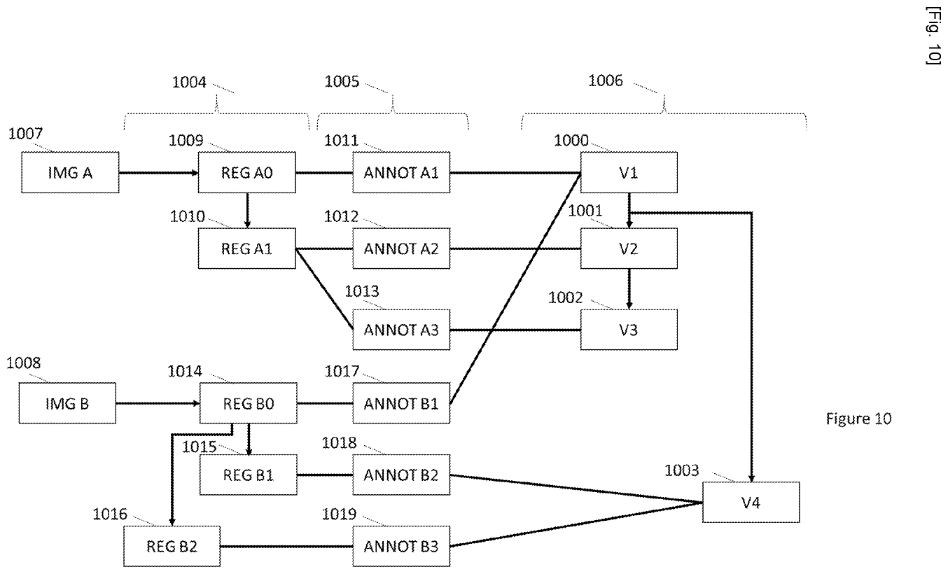

The annotation of images in the case of an application for assisting technicians coming to connect a house or a building to the optical fiber according to the embodiments is now described with reference to FIG. 10.

We first assume a first root classification view v1 1000 (V1) named “Context” with two classes (or type): “Wattmeter” and “Cabinet”. This allows us to differentiate between two types of photos taken by the technician: (i) either a photo of the device used to measure the signal power, called a wattmeter (we will then have to say whether the signal power displayed on the screen complies with the minimum threshold), (ii) or a photo of the fiber optic connection cabinet (we will then have to say whether the various connection zones are valid).

We also suppose a detection view v2 1001 (V2) named “Screen” having for parent the view v1 1000 and a single class (or type) “Screen”. Its role is to allow to locate the screen of the power meter to read it. This view 1001 has a condition. The region must be annotated “Wattmeter” in the parent view for an annotation to be associated with an image in this view.

We also suppose an OCR view v3 1002 named “Signal Quality” having for parent the v2 view 1001 whose goal is to allow to annotate the text on the screen. This view has no condition, that is ∀r∈R, c₃(r)=1 (according to the formalism described above).

A detection view v4 1003 named “Connection” having for parent the v1 view 1000 and two classes (or type) “OK” and “KO”. Its purpose is to identify compliant or non-compliant connection zones. This view has a condition. The region must be annotated “Cabinet” in the parent view for an annotation to be associated with an image in this view.

We now describe the link between data (in this case images) and regions 1004, annotations 1005 and views 1006 for two images 1007 and 1008. Each piece of data carries regions organized in the form of a tree starting from a root region that encompasses the whole piece of data. An annotation is attached to a region and a view. Depending on the type of view, the annotation can be a class, text, etc. Each view has a type and possibly a condition.

The image 1007 represents a power meter. We then define a first region 1009 which is a root region. We also define a sub-region 1010 around the power meter screen.

The region 1009 is thus annotated 1011 according to the “Wattmeter” class. The region 1010 receives two annotations: one is the “Screen” class 1012 and the other is the text recognized by OCR on the screen 1013 for example “−4.6 dB”. The annotations 1011, 1012, 1013 are thus respectively associated with views 1000, 1001, 1002.

The image 1008 represents a junction box. We then define a first region 1014 which is a root region. We also define a sub-region 1015 and a sub-region 1016 which correspond to two different zones of the cabinet.

Region 1014 is thus annotated 1017 according to the “Cabinet” class. Region 1015 is annotated “OK” 1018 because it has a compliant connection area. The region 1016 receives a “KO” annotation 1019 because it has a non-conforming connection zone. Annotation 1017 is associated with view v1 1000 because the presence of the cabinet is a “Context” annotation. Annotations 1018 and 1019 are both associated with view v4 1003 because the good or bad connection is a “Connection” annotation.

In the above formalization, conditions are applied to annotations in the parent view in general. The preceding examples show that in particular it may be important to be able to define conditions on the annotated classes in the parent region. Variations according to embodiments are now described.

The condition of a view vⱼ can for instance be about the class annotated in the parent view (if this one is unique, see paragraph below for the multi-class case) to restrict the annotation of vⱼ annotation to certain classes only. This allows for example to specialize views to certain contexts of shooting or objects, typically in order to structure and simplify the annotation work in order to have less classes (or types) to annotate.

Let's call classⱼ: Aⱼ→ [symbol] the class function that associates an annotation of vⱼ to its class represented as an integer, and Cⱼ the set of acceptable classes, then given a region r we have cⱼ (r)=1 if classₚ₍ⱼ₎(aₚ₍ⱼ₎(r))∈C_{j,0} otherwise.

In the multi-class case where the parent view allows annotating the region with several classes among a possible set of N classes, we can represent the class function by class: Aⱼ→{0,1}^{N} and the acceptable classes as a logical boolean formula over the classes: Cⱼ: {0,1}^{N}→{0,1}. In this case we have cⱼ (r)=Cⱼ(classₚ₍ⱼ₎(aₚ₍ⱼ₎(r))). This variant actually encompasses the previous case where we have only one annotated class at a time.

According to the embodiments when the annotation of the parent view does not comprise a notion of class, as for example in the case of pose estimation or a textual annotation, one can define “clusters” on which one can also apply conditions.

We use the notion of clustering when the annotation of a view vⱼ does not directly provide a class (or type). This is for example the case for a pose estimation task where the annotation corresponds to placing the nodes of a tree on the data. In this case, a partition of the annotation space can be calculated beforehand (clustering). This method divides the space Aⱼ into N groups (or “clusters”) and we can associate any annotation to the closest a ∈Aⱼ to the closest cluster, i.e. we have a function classⱼ: Aⱼ→ [symbol] that allows to associate a class to an annotation.

In some embodiments, each annotation can be associated with multiple clusters and the class function has the general form classⱼ: Aⱼ→{0,1}^{N}. We then fall back to the case of the previous paragraph for the multi-class annotation case.

In the above, tasks and views have been associated in a bijective way. However, according to embodiments, a task can be divided over several views in order to notably reduce the number of classes to be annotated in each view. This allows a person (or an annotation module) annotating to focus on fewer classes, thus being more efficient and making fewer errors.

This does not change the general embodiment according to which, in practice, it is sufficient to keep the bijective link between view and task. It is only when training a machine learning algorithm on a set of annotated datasets that it is necessary to be able to combine two sister views (i.e. having the same parent) into a single view.

As explained, the views system allows for the automation of data manipulation and annotations, so that the data stream annotated by the different views corresponds to a set of datasets that would share a hierarchical structure. In this scheme, once data has been annotated for a given view, we can then train a machine learning model on the dataset that corresponds to the annotated data of that view.

According to some embodiments, this means that a model is trained on the data annotated by a certain view. However, it can be interesting to train a model on several views.

It is then necessary to be able to merge the annotated data from several views into a single annotated data set.

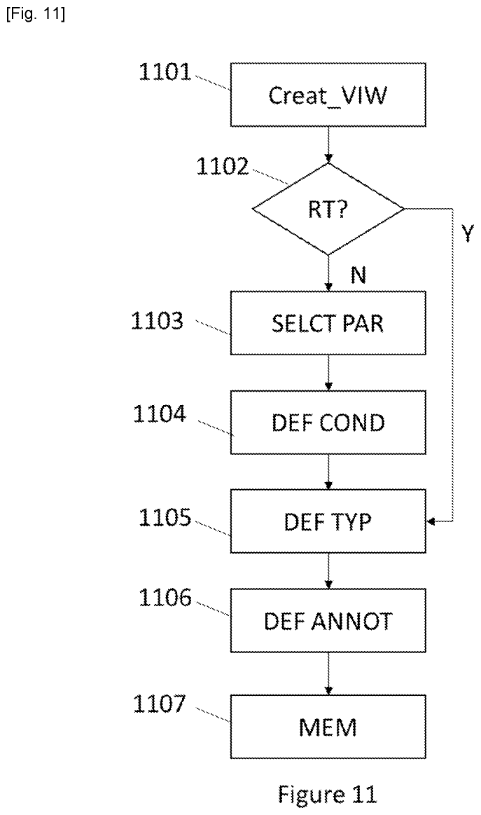

The steps of a process are now described with reference to FIG. 11 and following, using the formalism described above. This process can be implemented in the case of a computer-implemented annotation application, with for example an interface as described above. It is thus a user who interacts with the application, via the interface to annotate the data. Variations of the process can also be implemented in the context of an automatic annotation, by an AI for example.

In what follows, we consider that data (for example images) are already stored in memory and associated with their root region. This association is realized as soon as a data is added to the database: a root region is created for each added data. AIternatively, one can foresee in the following steps to add or remove data to an existing dataset, either by a user or automatically. These steps are not represented.

In the case of an application, the user can, for example, create an annotation project in which data to be annotated and annotations will be stored according to the invention. This is for example a “Meal trays” or “Fiber connection” project.

FIG. 11 describes the process of creating a view. In a step 1101, the description of a view, corresponding to a project task, is created. It is then determined (step 1102) whether this view is a root view. If it is not (N), the process continues with the selection of the parent view in step 1103. For example, the interface of FIG. 5 can be used, for example it is determined whether it is the button 513 or 515 that has been activated. In this case the determination of the parent view is done by determining the view previously selected by the user before clicking on one of these buttons. If button 508 has been activated, it is then determined (Y) that the view created is a root view.

Once the parent view is selected, a condition on that parent view is defined (step 1104) to allow filtering of data to be offered for annotation for the view created in step 1101. The exact form of this condition depends on the task type of the parent view. For example, if the parent view is a classification or detection view where only one class can be annotated, the condition may take the form of a drop-down list from which the user selects the various parent classes of interest, thereby defining the set C 1 of acceptable classes defined above. If the type of parent task is multi-class and allows to annotate several classes on the same region, the condition can be defined by a boolean formula whose clauses will relate to the presence of certain parent classes. Then, the type of annotations for this view is created (step 1105), i.e. the type of associated task (classification, OCR, pose, detection or other). Depending on the type of task, the annotation configuration is then defined (step 1106). For example, for annotations based on classes, the classes of interest are defined: “Screen” or “Cabinet” in the example of the fiber connection. This step is optional because the classes can be modified after the view is saved in memory: the user can use the buttons in the action area 601 of the interface 600 in FIG. 6 for example.

If the view created is a root view, the process goes from step 1102 (Y) to step 1105 directly.

Once this process is completed, the view description is stored in memory (step 1107).

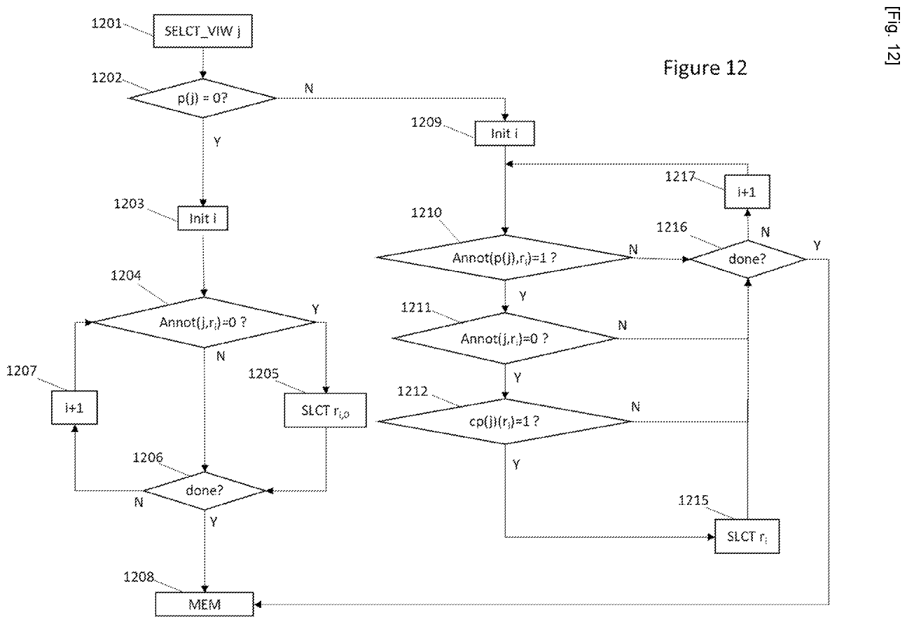

Next, with reference to FIG. 12, we describe the annotation process. It starts with the selection of a view vⱼ in step 1201. It is then determined in step 1202 whether the selected view is a root view or not.

If it is a root view (Y), we initialize a loop (step 1203) during which we will determine (step 1204) all the regions not yet annotated according to the current view. We therefore iterate on the root regions of the data in memory: if the region is not annotated by the view vⱼ the region is selected (step 1205). Otherwise (N) the region is ignored. Iteration is typically done via a query to a database but can be implemented by a counter i that traverses all root regions. In step 1206, if i has not yet finished iterating over the root regions (N), the loop is incremented (step 1207) or (Y), if all regions have been tested, a storage step 1208 of all regions filtered in step 1205 is performed. This is not a storage of a new dataset or the creation of a sub-dataset but the memorization of all the regions to be annotated according to the current view, typically according to a cursor returned in response to the database query.

This step is a prerequisite to a display of the data to the user, for example, to prepare for the display of the data to be annotated in the area 705 of the interface 700 of FIG. 7.

Back to step 1202, if the selected view is not a root view (N), then a loop is initialized (step 1209), during which, all regions of the data annotated by the parent view are determined (step 1210).

For each region annotated by the parent view (Y), it is determined whether it is annotated by the current view in step 1211. If the region is not annotated by the current view (Y), then it is determined (step 1212) whether the filtering condition of the parent view is met for the current region. If the condition is met (Y), then the region is selected (step 1215) to present it for annotation.

The process then continues until all regions have been considered. This is determined in step 1216. If there are still regions to be considered (N), the loop is incremented in step 1217 and the process continues at step 1210. Otherwise (Y), the process ends with step 1208 already described, storing the regions filtered in step 1215.

When testing steps 1210, 1211 and 1212, if the result is negative (N), the process continues with step 1216 as shown in FIG. 12.

The data corresponding to the regions to be annotated stored in step 1208 is either displayed for annotation by a user, for example via the interface 705, or provided to an automatic annotation module.

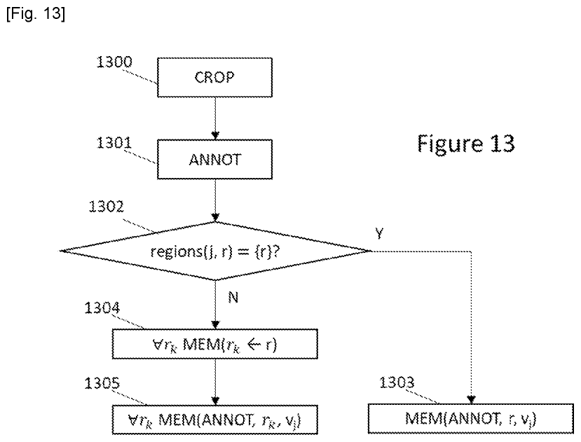

This annotation (manual or automatic) is described with reference to FIG. 13.

For each region r stored in step 1208, the user (human or algorithm) is presented with the data d to which r is attached, cropped by r. Formally, at step 1300, the data is presented to the user for annotation crop(d,r) is presented to the user for annotation according to the view vⱼ selected in 1201. In step 1301, an annotation is received for this data. It is then determined in step 1302 whether the type of task type related to vⱼ is region-creating. If this is not the case (Y), then the annotation is stored in step 1303. As already indicated, this memorization is done in relation, not to the data, but to the current view and the region to which the data belongs.

If on the other hand the annotation creates one or more regions (N), noted {rₖ}, for example if it is a view linked to a detection task, we go to a step 1304 of memorizing a relationship between the created regions and the regions from which they originate. Then, for each of the created regions, a step 1305 of memorizing the annotation related to the created region and the current view is performed. For example, in the context of detection, we associate an annotated class on a bounding box with the corresponding region.

At the end of the process, a database according to FIG. 9 is available that stores annotations related to views, regions and conditions. The database also contains the initial data.

As already explained, it is advantageous that no sub-datasets have been created. Thus, we can correct and update annotations at one level and easily propagate the changes to the child views, which contributes to the reliability of the annotation process.

Only the visualization can be done temporarily to allow the user to visualize the data of the sub-datasets and annotate them or to allow an automatic process to take them as inputs and annotate them. This process being realized data by data, it remains light and does not present any complexity of execution.

The generation of datasets is then done at the time of training the AI. Either it is done in one go, or on the fly as the training progresses.

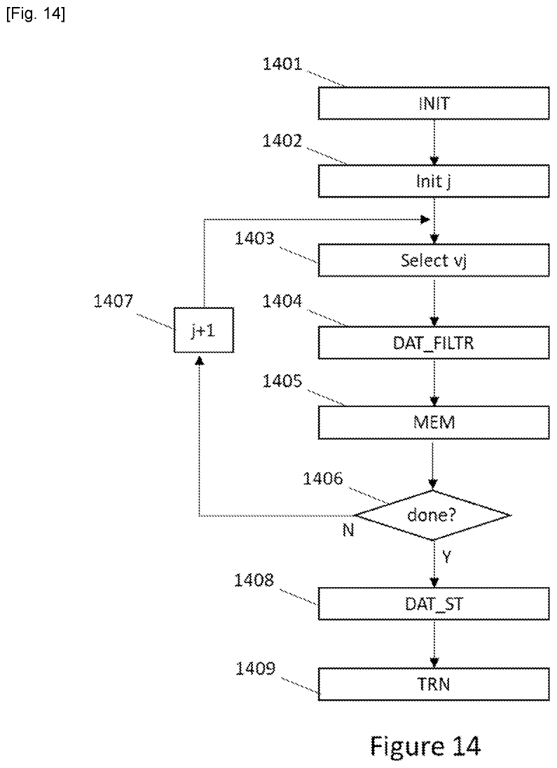

FIG. 14 illustrates a use of annotations produced according to embodiments.

The process is initialized by step 1401 during which annotations are accessed, for example a database as shown in FIG. 9. A loop is then initialized (step 1402) during which the different views vⱼ are selected (step 1403) and applied to the initial data in step 1404.

The result of the filtering is stored in memory at step 1405, with the annotations associated with the view vⱼ. Thus, here we make the link between the data and the annotations. We thus start to build the dataset that will be used by the AI.

We then check (step 1406) if all the views have been considered. If there are still views (N), the loop is incremented (step 1407) and we return to step 1403.

If all views have been used (Y), then we proceed to step 1408 of providing the dataset to the AI which can then be trained in step 1409 depending on the application.

In addition, one can also foresee that the data is also linked to particular applications. In this case, the views will also be applied to a subset of the data related to the considered application.

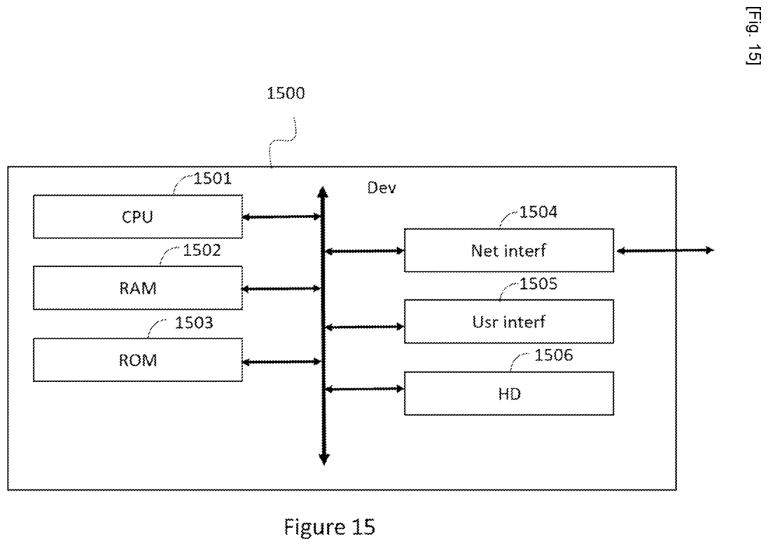

FIG. 15 is a block diagram of a system 1500 for implementing one or more embodiments of the invention. The processes according to embodiments are implemented by computer.

The system 1500 includes a communication bus to which are connected:
a processing unit 1501, such as a microprocessor, referred to as CPU;
a random access memory unit 1502, called RAM, for storing executable code of a method according to an embodiment of the invention, as well as registers adapted to store variables and parameters necessary for the implementation of a method according to embodiments, the memory capacity of which can be extended by an optional RAM connected to an expansion port for example.
a memory unit 1503, called ROM, for storing computer programs for implementing the embodiments of the invention.
a network interface unit 1504 connected to a communication network over which the digital data to be processed is transmitted or received. The network interface 1504 may be a single network interface or composed of a set of different network interfaces (e.g., wired and wireless interfaces, or different types of wired and wireless interfaces). Data is written to the network interface for transmission or read from the network interface for reception under the control of the software application running in the CPU 1501;
a graphical user interface unit 1505 for receiving input from a user or displaying information to a user.
a 1506 hard drive denoted HD
an I/O module 1507 to receive/send data from/to external systems such as a video source or a display.

The executable code may be stored either in read-only memory 1503, on hard disk 1506, or on a removable digital medium such as a disk. According to one embodiment, the executable code of the programs may be received by means of a communication network, via the network interface 1504, in order to be stored in one of the storage means of the communication system 1500, such as the hard disk 1506, prior to being executed.

The central processing unit 1501 is adapted to control and direct the execution of instructions or portions of software code of the program(s) according to embodiments of the invention, such instructions being stored in any of the aforementioned storage means. After power-up, the processing unit 1501 is capable of executing instructions from the main RAM 1502 relating to a software application after such instructions have been loaded from the ROM program 1503 or the hard disk (HD) 1506 for example. Such a software application, when executed by the CPU 1501, causes the steps of a method to be executed according to embodiments.

The present invention has been described and illustrated in this detailed description with reference to the accompanying figures. However, the present invention is not limited to the embodiments shown. Other variants, embodiments and combinations of features may be deduced and implemented by the person skilled in the art from the present description and the attached figures.

To meet specific needs, a person skilled in the field of the invention may apply modifications or adaptations.

In the claims, the term “comprise” does not exclude other elements or steps. The indefinite article “a” does not exclude the plural. The various features presented and/or claimed may advantageously be combined. Their presence in the description or in different dependent claims does not exclude the possibility of combining them. The reference signs should not be understood as limiting the scope of the invention.

1. A method of annotating training data for artificial intelligence comprising the following steps:
storing, in a database, a set of data to be annotated;
storing, in said database, at least a first description of a first facet for data selection in said set of data, said first description being associated with a first task to be performed by said artificial intelligence;
selecting said first facet in said database;
applying said first facet to data in said set of data to obtain first filtered data;
receive at least a first annotation of said first filtered data; and storing said first annotation in the database in association with said first facet.

2. The method of claim 1, wherein said database comprises a plurality of descriptions of a plurality of facets for data selection in said set of data and wherein:
said first description includes a hierarchical link to a second description of a second facet for data selection in the database; and
said first facet is applied to second filtered data obtained by applying said second facet to data of said set of data.

3. The method according to claim 2, wherein:
said second facet covers a plurality of regions in said set of data; and
the first facet is applied on each region on which the second facet is applied.

4. The method according to claim 3, wherein:
annotations are associated with some of said regions covered by said second facet as well as with said second facet; and
the first facet is applied on each region carrying an annotation associated with the second facet.

5. The method according to claim 2, wherein the description of the first facet comprises a filtering condition applied to the annotations associated with said regions as well as to said second facet and wherein the first facet is applied only for those regions for which said filtering condition is verified.

6. The method according to claim 5, wherein said filtering condition is associated with the regions annotated by said second facet and wherein the first facet is applied only to data from a cropping by these regions and for which the condition is verified.

7. The method according to claim 6, wherein said annotation generates the definition of a region in said set of data, wherein said region is stored in a database in relation to the region used to crop the annotated data and wherein said annotation is stored in said database in relation to said first facet and said region.

8. The method according to claim 6, wherein said annotation does not create a new region, and wherein said annotation is stored in said database in relation to said first facet as well as the region used to crop the annotated data.

9. The method according to claim 1, further comprising a step of displaying said first filtered data to a user, said annotation being received from said user.

10. The method according to claim 1, wherein said first filtered data is provided as input to an artificial intelligence module implementing said task, said annotation being received from said module.

11. A machine learning method for performing a task by an artificial intelligence, comprising the following steps:
accessing a database comprising a set of data and at least one definition of at least one facet for data selection in said set of data, said one definition further comprising at least one annotation associated with said facet;
applying said data selection facet to said set of data to obtain first filtered data;
storing said first filtered data in an annotated training data memory;
associating said first filtered data with annotations; and
performing said task by said artificial intelligence.

12. The method according to claim 11, wherein, said annotation is generated according to a method of annotating training data for artificial intelligence comprising the following steps:
storing, in a database, a set of data to be annotated;
storing, in said database, at least a first description of a first facet for data selection in said set of data, said first description being associated with a first task to be performed by said artificial intelligence;
selecting said first facet in said database;
applying said first facet to data in said set of data to obtain first filtered data;
receive at least a first annotation of said first filtered data; and
storing said first annotation in the database in association with said first facet.

13. A device comprising a processing unit configured to implement steps according to the method according to claim 1.

14. A device comprising a processing unit configured to implement steps according to the method according to claim 11.
